(19) United States
(12) Patent Application Publication
(10) Pub. No.: US 2006/0115720 A1
(43) Pub. Date: Jun. 1, 2006

(54) Battery module

(76) Inventor: Tae-Yong Kim, Suwon-si (KR)

Correspondence Address: LEE & MORSE, P.C., 1101 WILSON BOULEVARD, SUITE 2000, ARLINGTON, VA, 22209, US

(21) Appl. No.: 11/288,084

(22) Filed: Nov. 29, 2005

(30) Foreign Application Priority Data
Nov. 30, 2004 (KR) 10-2004-0099316

(51) Int. Cl. H01M 6/42; H01M 10/50

(52) U.S. Cl. 429/156; 429/120

(57) ABSTRACT

A battery module includes unit batteries spaced apart from each other and having a cooling medium flow path defined in the space. The battery module includes a barrier rib disposed between the unit batteries, the barrier rib having a plurality of interconnected protrusions.

### BACKGROUND OF THE INVENTION

1. Field of the Invention

The present invention relates to a battery module. More particularly, the present invention relates to a battery module suitable for a secondary battery and including a plurality of unit batteries and a barrier rib disposed between adjacent unit batteries.

2. Description of the Related Art

As generally understood in the art, a primary battery is a single use battery. In contrast, a secondary battery, commonly known as a rechargeable battery, may be repeatedly discharged and recharged. Secondary batteries are generally classified into different types based on the external shape of the secondary battery. Common secondary battery types include prismatic, e.g., square, and cylindrical batteries. Low power batteries may be used for various portable electronic devices, e.g., cellular phones, laptop computers, camcorders, etc. Larger, bulk size batteries may be used as a power source for drive motor, e.g., as used in hybrid electric vehicles (HEVs).

In order to be used for high power or high capacity applications, e.g., drive motors, HEVs, etc., multiple batteries may be assembled in the form of a battery module. The battery module may be formed by connecting, e.g., serially connecting, several individual batteries. For clarity, individual batteries will be referred to herein as “unit batteries,” and assemblies of unit batteries connected in series, parallel, or a combination thereof, will be referred to as “battery modules”.

In a battery module each of the respective unit batteries may include an electrode assembly, in which a separator is interposed between a positive electrode and a negative electrode. The electrode assembly may be inserted inside a container, and a cap assembly may be attached to the container to seal the container. The cap assembly may include terminals disposed so as to extend from the inside to the outside of the container, which are electrically connected to the positive and negative electrodes.

Unit batteries may be arranged to alternate positive and negative terminals, such that a positive terminal of a first unit battery may be disposed adjacent to a negative terminal of an adjacent second unit battery. Conductors may be mounted on threaded positive and negative terminals to electrically connect adjacent unit batteries to form the battery module.

A battery module may include several unit batteries to tens of unit batteries. As the unit batteries may generate heat, in a module containing multiple unit batteries there may be a need to efficiently discharge heat generated from each unit battery. In particular, when the battery module is a large, bulk size secondary battery module for, e.g., drive motors, HEVs, electric vehicles, electric scooters, rechargeable vacuum cleaners, etc., the efficient discharge of heat may be of significant importance.

If heat emission from the battery module is not properly managed, the temperature of the battery module may increase excessively, due to heat generated by each unit battery, and the battery module, and the machine connected thereto, may malfunction.

Accordingly, in forming the battery module, a barrier rib may be disposed between unit batteries. A space between unit batteries, formed by the barrier rib, may be used for cooling unit batteries, and the barrier rib may help prevent distortion due to heat expansion of the unit batteries. To perform such functions, the barrier rib needs sufficient strength and a structure conducive to efficient heat transfer. However, barrier ribs in conventional battery modules do not satisfactorily perform the above two functions simultaneously. That is, the barrier ribs may be made to ensure sufficient strength, but this may result in increased manufacturing costs and may limit design freedom regarding providing for cooling. Alternatively, the barrier ribs may be designed to provide high cooling efficiency, but this may result in structural weakness. Accordingly, there is a need for barrier ribs and battery modules offering higher performance in these and other respects and that satisfy consumer expectations regarding strength, weight and cooling.

### SUMMARY OF THE INVENTION

The present invention is therefore directed to a battery module that substantially overcomes one or more of the problems due to the limitations and disadvantages of the related art.

It is therefore a feature of an embodiment of the present invention to provide a battery module having sufficient structural strength to maintain the shape of unit batteries therein.

It is therefore another feature of an embodiment of the present invention to provide a battery module having barrier ribs with a structure that reduces the weight of the battery module.

It is therefore yet another feature of an embodiment of the present invention to provide a battery module having sufficient structural strength to maintain the shape of unit batteries therein while providing for efficient cooling of the battery module.

At least one of the above and other features and advantages of the present invention may be realized by providing a battery module including a plurality of unit batteries, and at least one barrier rib disposed between two adjacent unit batteries, wherein the barrier rib includes a plurality of interconnected protrusions.

Each protrusion has a height, and the two adjacent unit batteries may be separated by the height. A cooling medium flow path may be defined between the two adjacent unit batteries and between the protrusions. The cooling medium flow path may include at least two routes around each protrusion. The battery module may further include a plurality of supporting bars interconnecting the protrusions, wherein the cooling medium flow path is defined between the protrusions and across each supporting bar. The protrusions may be arranged in a grid pattern. The barrier rib may further include supporting bars interconnecting the protrusions. The supporting bars may each interconnect two adjacent protrusions. The barrier rib may further include a substantially planar panel disposed directly adjacent to the supporting bars and to one side of the protrusions. The protrusions may each protrude from the barrier rib in a same direction.

The barrier rib may include first and second rib members, each rib member having protrusions projecting therefrom, wherein the first and second rib members are disposed adjacent to each other and arranged such that protrusions on the first rib member project in a direction opposite to the protrusions on the second rib member. The protrusions on the first and second rib members may have a same shape. The protrusions may have a conical shape with a cutaway apex area, such that the protrusions have a wide side and a narrow side. The protrusions may have substantially hemispherical cross-sections. The protrusions may have substantially rectangular cross-sections. The protrusions may have substantially triangular cross-sections. The unit batteries may be prismatic batteries.

At least one of the above and other features and advantages of the present invention may also be realized by providing a battery module including a housing having a cooling medium inlet and a cooling medium outlet, at least two adjacent unit batteries, and at least one barrier rib defining a space between the two adjacent unit batteries, wherein a cooling medium flow path is defined between the two adjacent unit batteries and traversing the space, the barrier rib includes a plurality of protrusions interconnected by supporting bars, and an angle defined between adjacent supporting bars is between about 30° and about 150°. The angle may be between about 45° and about 60°. A line that bisects the angle may be substantially perpendicular to the cooling medium flow path.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a cross-sectional view of a side of a battery module according to a first embodiment of the present invention;

FIG. 2 illustrates a perspective view of a barrier rib in the battery module of FIG. 1;

FIG. 3 illustrates a cross-section taken along line III-III of FIG. 2;

FIGS. 4 and 5 illustrate cross-sections of additional examples of barrier ribs according to the first embodiment of the present invention;

FIG. 6 illustrates a cross-section of a barrier rib of a battery module according to a second embodiment of the present invention;

FIGS. 7 and 8 illustrate cross-sections of additional examples of barrier ribs of the battery module according to the second embodiment of the present invention;

FIG. 9 illustrates a cross-section of a barrier rib of a battery module according to a third embodiment of the present invention;

FIGS. 10 and 11 illustrate cross-sections of additional examples of barrier ribs of the battery module according to the third embodiment of the present invention;

FIG. 12 illustrates a cross-section of a barrier rib of a battery module according to a fourth embodiment of the present invention;

FIGS. 13 and 14 illustrate cross-sections of additional examples of barrier ribs of the battery module according the fourth embodiment of the present invention;

FIG. 15 illustrates a schematic of function of the barrier ribs according to the first embodiment of the present invention; and

FIG. 16 illustrates a schematic block diagram of a secondary battery module for a drive motor.

### DETAILED DESCRIPTION OF THE INVENTION

Korean Patent Application No. 10-2004-0099316, filed on Nov. 30, 2004, in the Korean Intellectual Property Office, and entitled: “Secondary Battery Module,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

A battery module in accordance with the present invention may be suitable for use as a secondary battery module and may be provided with substantial strength by the inclusion of barrier ribs having protrusions, which enable unit batteries in the battery module to be efficiently cooled and help prevent distortion of the unit batteries due to, e.g., high temperatures. Moreover, the battery module according to the present invention may have a reduced weight, which may enable a broader array of applications and provide more design freedom for devices that include the battery module.

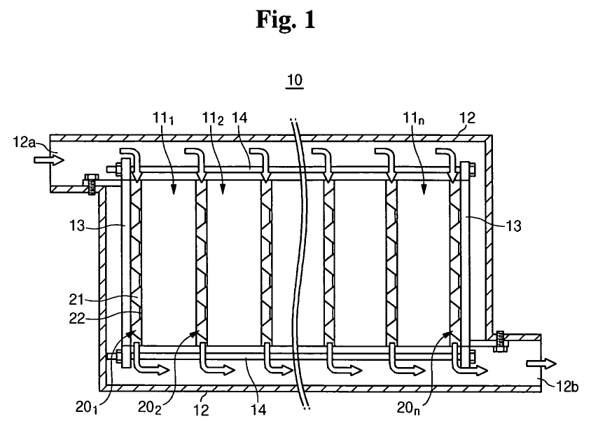

FIG. 1 illustrates a cross-sectional view of a side of a battery module according to a first embodiment of the present invention. Referring to FIG. 1, a secondary battery module 10 according to the present embodiment may include a plurality of unit batteries 11 (referred to individually as 11₁, 11₂, . . . 11ₙ) spaced apart from each other by a predetermined distance. The unit battery 11 in the present embodiment may be a square type, or prismatic, secondary battery, which, as a general secondary battery, may include a container, an electrode assembly including a positive electrode, a negative electrode, a separator inserted in the container, and a cap assembly disposed in the container.

Barrier ribs 20 may be disposed between the unit batteries 11 to enable a cooling medium to flow between adjacent unit batteries 11. For simplicity, the following description will use air as an exemplary cooling medium, although the present invention is not limited thereto. The barrier ribs 20 may be connected to the unit batteries 11 to provide support for the unit batteries 11. The barrier ribs may be made of, e.g., an insulating material such as plastic or ceramic, a metal such as aluminum, etc.

The unit batteries 11 and the barrier ribs 20 may be fastened together, e.g., by fasteners run through end plates 13 disposed at the two outermost ends, to form an aggregate comprised of unit batteries 11 and the barrier ribs 20. The fasteners may be, e.g., restraint rods 14 combined with the end plates 13 by a screw thread to clamp the unit batteries 11 and the barrier ribs 20 together and thereby form an assembly.

The assembly may be mounted in a housing 12 having an inlet 12a, for receiving air that cools the unit batteries, and an outlet 12b, for discharging heated air that has cooled the unit batteries 11. The assembly may be fixed in the housing 12 by detachably mounting the end plates 13 to the housing 12 using one or more screws.

The housing inlet 12a may be disposed in one side of an upper portion of the housing 12, and the outlet 12b may be disposed in one side of a lower portion of the housing 12a and may be opposite to the inlet 12a. However, a structure such as that illustrated in FIG. 1 is merely exemplary, and the battery module of the present invention may be implemented in a variety of other arrangements. Accordingly, the present invention is not limited to the particular arrangements described and illustrated herein.

The assembly of unit batteries 11 and barrier ribs 20 may be disposed in the housing 12 with respect to the inlet 12a and the outlet 12b such that air entering the battery module 10 through the inlet 12a flows from an upper portion of the housing 12 to a lower portion of the housing 12, traversing the assembly, and exits through the outlet 12b. During this process, the air passes through the barrier ribs 20, and the heat generated from the unit batteries 11 is heat-exchanged by the air to cool them.

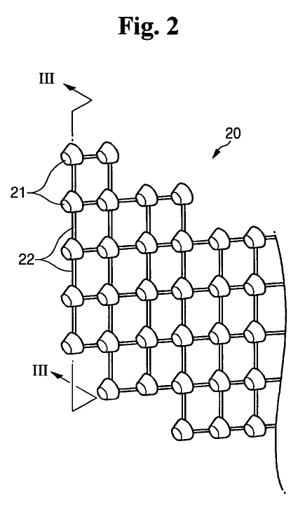

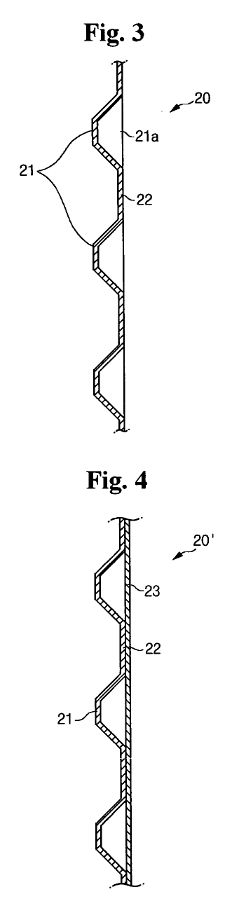

Further details of the battery module 10 having the above function will now be described. Referring to FIGS. 2 and 3, the barrier ribs 20 may include a plurality of protrusions 21, which protrude by a predetermined height and are spaced apart from each other. The protrusions 21 may each be substantially surrounded by free space, such that the cooling medium may pass around all sides of the protrusions 21. The barrier ribs 20 may also include a supporting bar 22 integrally connected to the plurality of protrusions 21 to support them. The protrusions may be made of, e.g., an insulating material such as plastic or ceramic, a metal such as aluminum, etc.

When the barrier ribs 20 are disposed between the unit batteries 11, the top surface and the bottom surface of each protrusion 21 may closely contact the side surfaces of each unit battery container in order to support the unit batteries 11. This maintains a predetermined gap between adjacent unit batteries 11 and helps prevent distortion of the unit batteries 11.

In addition, the plurality of protrusions effectively forms channels, or flow paths, through regions defined between the protrusions 21, thereby containing and directing air to cool the unit batteries 11. The protrusions may be arranged in a regular pattern, e.g., an array. Thus, the plurality of protrusions, when in place between, and in contact with, the side surfaces of the respective adjacent unit batteries, may form a plurality of cooling medium flow paths.

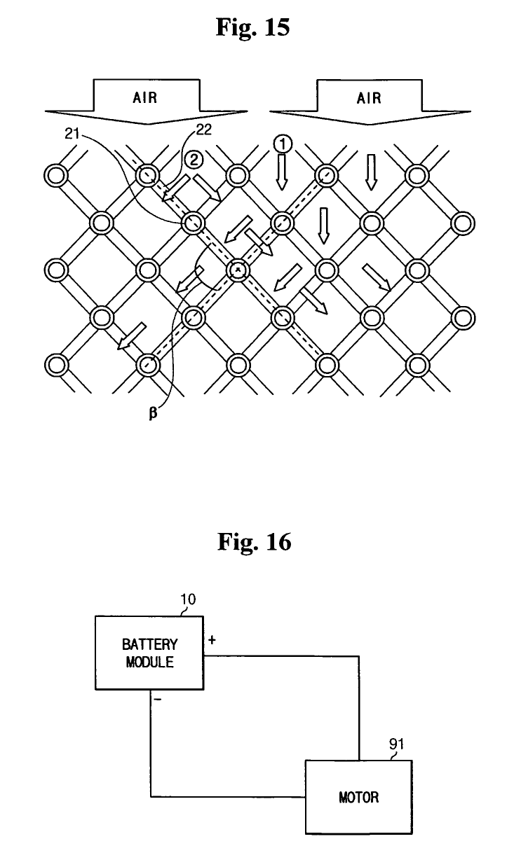

FIG. 15 illustrates a schematic of function of the barrier ribs according to the first embodiment of the present invention. Referring to FIGS. 1 and 15, the cooling medium flow paths may direct the cooling medium between the adjacent unit batteries 11. For example, in the battery module 10 illustrated in FIG. 1, the flow path directs the cooling medium from the tops to the bottoms of the unit batteries 11, i.e., the cooling medium, e.g., air, enters each barrier rib 20 at the top and exits each barrier rib 20 through the bottom. Further, referring to FIG. 15, the cooling medium may follow a convoluted flow path between the top and the bottom.

In particular, as illustrated in FIG. 15, the pattern of protrusions 21 may be disposed so as to cause the cooling medium to flow in a number of directions. That is, while the cooling medium may generally flow from top to bottom, as indicated by arrow \textcircled{1} in FIG. 15, the flow may include numerous diversions to the left and the right, as indicated by arrow \textcircled{2}. Accordingly, the cooling medium may undergo significant mixing, which may improve cooling by, e.g., minimizing the thickness of a cooling medium boundary layer that exists at the interface of the cooling medium and the sidewall of the unit battery. Accordingly, the barrier rib 20 according to the present invention may provide enhanced heat exchange, i.e., cooling, as compared to a barrier rib having a simple configuration, e.g., a corrugated configuration.

The protrusions 21 may be hollow or solid. As shown in FIG. 3, the protrusions 21 are hollow, as indicated by hollow region 21a. The protrusions 21 according to the first embodiment of the present invention may have a substantially conical shape, or truncated conical shape, with a flat, cutaway apex area, such that each protrusion 21 is wide on one side (the base of the cone) and narrow at the other (the top of the cone). The narrow side may contact a first unit battery and the wide side may contact a second unit battery. For example, as illustrated in FIG. 1, the narrow sides of the protrusions 21 on barrier rib 202 may contact the right-hand side of the container of unit battery 11₁, while the wide sides of the protrusions 21 on the barrier rib 20₂ may contact the left-hand side of the container of the adjacent unit battery 11₂.

The height from the base of the cone to the top of the cone of the protrusions 21 may define the height of the barrier rib 20. Accordingly, a gap between the unit battery 11₁ and the adjacent unit battery 11₂ may be defined by the height of the protrusions 21. Thus, the particular shape and dimensions of the protrusions 21 may be chosen based on the overall design requirements of the battery module.

The supporting bar 22 may be made of the same material as the protrusions 21. Each supporting bar 22 may be connected only between the closest ones of the adjacent protrusions 21. Each supporting bar 22 may be integrally formed with the protrusions 21. That is, the protrusions 21 and the supporting bars 22 may be formed from a monolithic piece of material. For example, the barrier rib 20 may be stamped from a single sheet of aluminum.

It will be appreciated that the terms “protrusion” and “supporting bar” are used in order to clearly describe embodiments of the present invention, but the present invention is not limited thereby. For example, the protrusions and supporting bars may run together in some embodiments of the present invention, i.e., the barrier rib may be formed as a dimpled sheet of aluminum, which may additionally have voids removed therefrom between the dimples, e.g., by perforating, punching holes, etc. Accordingly, such a barrier rib may have a smoothly convoluted cross-section wherein the protrusions (dimples) and the supporting bars (aluminum sheet between the dimples) transition smoothly therebetween. Thus, the present invention is not limited by the separate use of the terms protrusions and supporting bars.

The barrier ribs 20 may be installed between the unit batteries 11 to support the unit batteries 11. Further, the barrier ribs 20 may serve to maintain a predetermined gap between the unit batteries 11. Accordingly, during operation of the battery module 10, the barrier ribs 20 may help prevent distortion of the unit batteries 11 due to heat, physical stresses, etc., which may arise both inside and outside of the battery container, and may maintain adequate clearance between adjacent unit batteries 11 for cooling. Moreover, as the barrier ribs 20 according to the present invention may perform the desired function while having a design that includes significant amounts of empty space, e.g., between the protrusions 21, between the supporting bars 22, in the hollow regions 21a, etc., the barrier ribs may provide additional benefits by reducing the overall weight of the battery module 10.

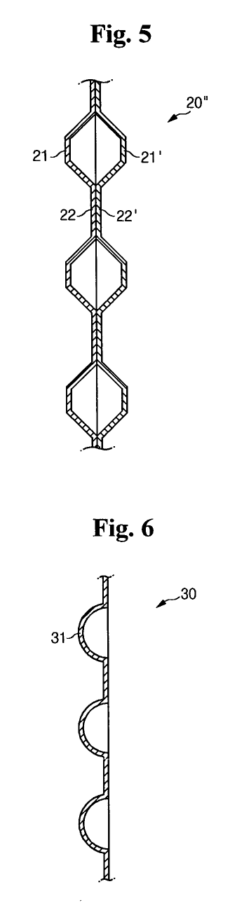

FIGS. 4 and 5 illustrate cross-sections of additional examples of barrier ribs according to the first embodiment of the present invention. Referring to FIG. 4, a barrier rib 20′ may have the same basic structure and material as the barrier rib 20 of FIG. 3, and further include a flat panel 23, having a substantially planar shape, disposed on one surface of the protrusions 21. The flat panel 23 may be disposed on the surface of the barrier rib 20′ that includes the supporting bars 22. The flat panel 23 may be affixed to the protrusions 21 and/or the supporting bars 22 by any suitable means, including welding, etc.

The barrier rib 20′ may be disposed between adjacent unit batteries 11, such that the flat panel 23 is in close contact with one of the unit batteries. Thus, the flat panel 23 may increase the contact area with the unit battery 11, which may enhance its performance in, e.g., supporting the container of the unit battery 11.

Referring to FIG. 5, a barrier rib 20″ may have the same basic structure and material as the barrier rib 20 of FIG. 3, and further include a second, mirror image member. Thus, the two members may form a matched pair, in which the protrusions 21 are disposed opposite to matching, mirror image protrusions 21′ and the supporting bars 22 are similarly matched by supporting bars 22′. In particular, the mirror image members may be arranged such that the narrow surfaces of the protrusions 21, 21′, i.e., the tops, are disposed to face outward. That is, the mirror image members may be arranged back-to-back. Thus, the barrier rib 20″ may exhibit enhanced strength and provide increased volumes for cooling channels. Accordingly, the barrier rib 20″ may flow more air than the corresponding single-member barrier rib 20. Therefore, the barrier rib 20″ may be suitable for larger secondary battery modules.

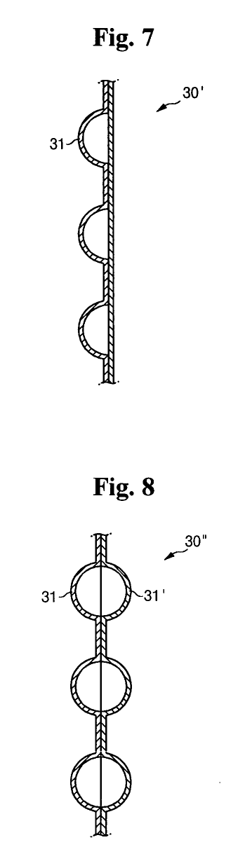

FIG. 6 illustrates a cross-section of a barrier rib of a battery module according to a second embodiment of the present invention, and FIGS. 7 and 8 illustrate cross-sections of additional examples of barrier ribs of the battery module according to the second embodiment of the present invention. Referring to FIG. 6, a barrier rib 30 may have a similar structure to the barrier rib 20 of FIG. 3 and may include protrusions 31 that have a rounded or substantially hemispherical cross-section. Referring to FIGS. 7 and 8, barrier ribs 30′ and 30″ may have a flat panel and a mirror-image member (having protrusions 31 matched by protrusions 31′), respectively, disposed along and attached to one side, in a similar fashion to barrier ribs 20′ and 20″ described above.

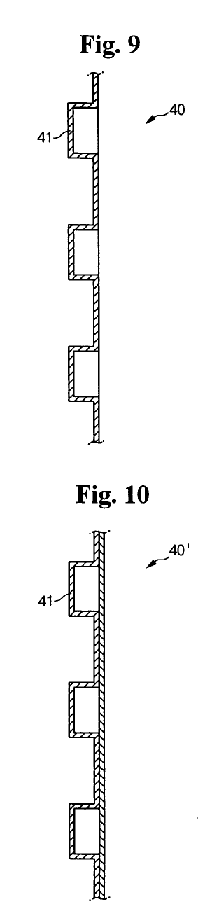

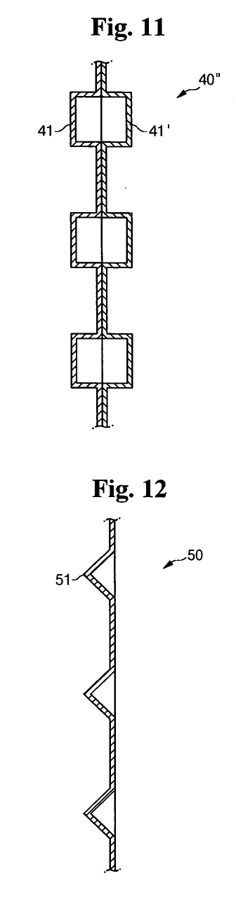

FIG. 9 illustrates a cross-section of a barrier rib of a battery module according to a third embodiment of the present invention, and FIGS. 10 and 11 illustrate cross-sections of additional examples of barrier ribs of the battery module according to the third embodiment of the present invention. Referring to FIG. 9, a barrier rib 40 may have the same basic structure as the barrier rib 20 of FIG. 3 and may include protrusions 41 that have a square or substantially rectangular cross-section. Referring to FIGS. 10 and 11, barrier ribs 40′ and 40″ may have a flat panel and a mirror-image member (having protrusions 41 matched by protrusions 41′), respectively, disposed along and attached to one side, in a similar fashion to barrier ribs 20′ and 20″ described above.

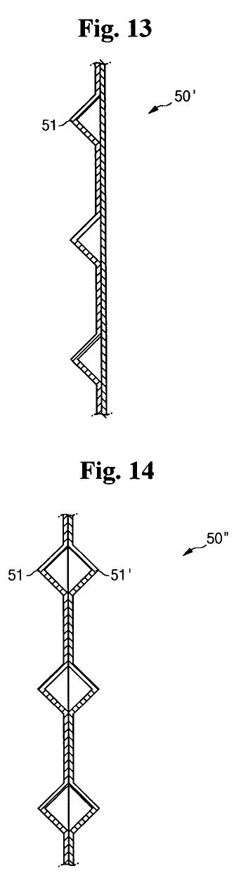

FIG. 12 illustrates a cross-section of a barrier rib of a battery module according to a fourth embodiment of the present invention, and FIGS. 13 and 14 illustrate cross-sections of additional examples of barrier ribs of the battery module according to the fourth embodiment of the present invention. Referring to FIG. 12, a barrier rib 50 may have the same basic structure as the barrier rib 20 of FIG. 3 and may include protrusions 51 that have a substantially triangular cross-section. Referring to FIGS. 13 to 14, barrier ribs 50′ and 50″ may have a flat panel and a mirror-image member (having protrusions 51 matched by protrusions 51′), respectively, disposed along and attached to one side, in a similar fashion to barrier ribs 20′ and 20″ described above.

The barrier ribs 30-50″ of the embodiments illustrated in FIGS. 6-14 may perform the same functions as the barrier ribs 20, 20′ and 20″, and may differ only in the shape of the protrusions. Accordingly, for the sake of clarity, the protrusions 31-51″, respectively, have been described without repeating other details that are substantially the same across the various embodiments. Further, the barrier ribs 20-50″ described above are merely exemplary, and the present invention is not limited thereto. For example, the protrusions 21-51″ may be formed in a variety of suitable shapes. Accordingly, the present Invention is not limited to the illustrated shapes, and may be modified in various forms.

The protrusions 21-51″ of the barrier ribs 20-50″, respectively, may be arranged to satisfy Formula 1, below. For clarity, in the description that follows only the barrier rib 20 and the corresponding protrusions 21 will be expressly referred to, with the understanding that the following description is equally applicable to the other embodiments of the present invention.

Referring again to FIG. 15, the protrusions 21 may be disposed in a regular pattern, e.g., a staggered array, and may be connected by the supporting bars 22. The regular pattern may include an angle (β) defined by the protrusions, and β may satisfy the following Formula 1:
30°≦β≦150° (Formula 1)
where β is an included angle defined by three adjacent protrusions, wherein one of the three protrusions is disposed at a vertex of the included angle. That is, with respect to a first protrusion disposed in a first column of protrusions, an angle between the first protrusion and two other protrusions disposed in an adjacent second column of protrusions, defined by virtual lines intersecting at the first protrusion, such that a virtual line that bisects the angle β is substantially perpendicular to the overall or general direction of flow of the cooling medium, which is indicated by arrow \textcircled{1}.

In addition, the angle β may satisfy the following Formula 2:
45°≦β≦60° (Formula 2)

In operation, referring to FIGS. 1 and 15, when the protrusions are arranged according to Formulas 1 and/or 2, when the cooling medium, e.g., air, flows into the barrier rib 20 via the inlet 12a of the housing 12 to contact a protrusion 21 of the barrier rib 20, it is dispersed into two directions with respect to the protrusion 21 (the overall direction of incoming air is indicated by arrow \textcircled{1} in FIG. 15; the dispersion in two directions is indicated by arrow \textcircled{2} in FIG. 15). Accordingly, in the battery module 10 according to the present invention, the cooling medium passing through the barrier rib 20 is dispersed at the protrusions 21, so that it changes directions repeatedly as it progresses along the flow path defined by the barrier rib 20. If the angle β is less than 30°, the heat exchange efficiency may become too low, and if the angle β is more than 150°, the speed of cooling medium, e.g., the air flow rate, may become too low to effectively cool the unit batteries 11.

In some implementations, it may be desirable to attempt to maximize the cooling efficiency of the unit batteries 11 by adjusting the speed, or flow rate, of the cooling medium through the barrier rib 20. If the cooling medium, e.g., air, does not have the proper speed, when the cooling medium passes through the barrier rib 20 it may not be effectively dispersed within the barrier rib 20, which may impair heat exchange and thereby decrease of the cooling efficiency of the unit batteries 11.

Furthermore, air flow through the barrier rib 20 should be adjusted with consideration of the pressure drop across the barrier rib 20. An excessive pressure drop, i.e., an increased resistance to air passing through the housing 12, may impair cooling of the unit batteries 11. Further, an excessive pressure drop may place an increased load on an apparatus providing air to the housing 12, e.g., a cooling fan, if one is employed. Accordingly, the flow rate, or speed, of the cooling medium, and the overall cooling efficiency of the unit batteries 11, may be optimized by maintaining the angle β according to Formulas 1 and/or 2, as described above.

FIG. 16 is a block diagram schematically illustrating driving the motor 91 by the battery module 10 shown in FIG. 1. The battery module 10 according to the present invention may be used as a secondary battery module for, e.g., motor driven machines such as HEVs, electric vehicles, electric scooters, electric bikes, cordless vacuum cleaners, etc., which require high power.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery module comprising:
a plurality of unit batteries; and
at least one barrier rib disposed between two adjacent unit batteries, wherein the barrier rib includes a plurality of interconnected protrusions.

2. The battery module as claimed in claim 1, wherein each protrusion has a height, and the two adjacent unit batteries are separated by the height.

3. The battery module as claimed in claim 1, wherein a cooling medium flow path is defined between the two adjacent unit batteries and between the protrusions.

4. The battery module as claimed in claim 3, wherein the cooling medium flow path includes at least two routes around each protrusion.

5. The battery module as claimed in claim 3, further comprising a plurality of supporting bars interconnecting the protrusions, wherein the cooling medium flow path is defined between the protrusions and across each supporting bar.

6. The battery module as claimed in claim 1, wherein the protrusions are arranged in a grid pattern.

7. The battery module as claimed in claim 1, wherein the barrier rib further includes supporting bars interconnecting the protrusions.

8. The battery module as claimed in claim 7, wherein the supporting bars each interconnect two adjacent protrusions.

9. The battery module as claimed in claim 7, wherein the barrier rib further includes a substantially planar panel disposed directly adjacent to the supporting bars and to one side of the protrusions.

10. The battery module as claimed in claim 1, wherein the protrusions each protrude from the barrier rib in a same direction.

11. The battery module as claimed in claim 1, wherein the barrier rib includes first and second rib members, each rib member having protrusions projecting therefrom, wherein the first and second rib members are disposed adjacent to each other and arranged such that protrusions on the first rib member project in a direction opposite to the protrusions on the second rib member.

12. The battery module as claimed in claim 11, wherein the protrusions on the first and second rib members have a same shape.

13. The battery module as claimed in claim 1, wherein the protrusions have a conical shape with a cutaway apex area, such that the protrusions have a wide side and a narrow side.

14. The battery module as claimed in claim 1, wherein the protrusions have substantially hemispherical cross-sections.

15. The battery module as claimed in claim 1, wherein the protrusions have substantially rectangular cross-sections.

16. The battery module as claimed in claim 1, wherein the protrusions have substantially triangular cross-sections.

17. The battery module as claimed in claim 1, wherein the unit batteries are prismatic batteries.

18. The battery module as claimed in claim 1, wherein the battery module is used for a motor driven device.

19. A battery module comprising:
a housing having a cooling medium inlet and a cooling medium outlet;
at least two adjacent unit batteries; and
at least one barrier rib defining a space between the two adjacent unit batteries, wherein:
a cooling medium flow path is defined between the two adjacent unit batteries and traversing the space,
the barrier rib includes a plurality of protrusions interconnected by supporting bars, and
an angle defined between adjacent supporting bars is between about 30° and about 150°.

20. The battery module of claim 19, wherein the angle is between about 45° and about 60°.

21. The battery module of claim 19, wherein a line that bisects the angle is substantially perpendicular to the cooling medium flow path.
